(19) United States
(12) Patent Application Publication
(10) Pub. No.: US 2008/0018742 A1
(43) Pub. Date: Jan. 24, 2008

(54) Analog front-end device and imaging apparatus

(76) Inventors: Toshinobu Hatano, Kyoto (JP); Keiichi Tsumura, Osaka (JP); Masakatsu Furuichi, Osaka (JP)

Correspondence Address: MCDERMOTT WILL & EMERY LLP, 600 13TH STREET, NW, WASHINGTON, DC, 20005-3096, US

(21) Appl. No.: 11/826,092

(22) Filed: Jul. 12, 2007

(30) Foreign Application Priority Data
Jul. 21, 2006 (JP) 2006-199962

(51) Int. Cl. H04N 5/225

(52) U.S. Cl. 348/207.1; 348/E05.024

(57) ABSTRACT

The analog front-end device of the invention includes an analog-digital converter for generating digital data corresponding to an analog charge signal and a RAM for storing therein digital data generated by the analog-digital converter. A memory control section reads digital data stored in the RAM during the time period when the output of an image sensor is invalid, and outputs the digital data externally via the data output section.

### CROSS-REFERENCE TO RELATED APPLICATIONS

This application claims priority under 35 U.S.C. §119 on Patent Application No. 2006-199962 filed in Japan on Jul. 21, 2006, the entire contents of which are hereby incorporated by reference.

### BACKGROUND OF THE INVENTION

1. Field of the Invention

The present invention relates to an analog front-end device for converting a video signal (analog charge signal) outputted from an image sensor for a digital camera and the like to digital data corresponding to the analog charge signal, and an imaging apparatus using such an analog front-end device.

2. Description of the Prior Art

In recent years, the camera industry has experienced the remarkable transition from analog technology to digital technology. In particular, digital still cameras requiring no film or development have been enjoying a boom. In the cellular phone industry, camera-mounted cellular phones are now in the mainstream. Digital still cameras have also remarkably achieved increase in the number of pixels and improvement in image quality by image processing.

Such a digital still camera incorporates an analog front-end device that converts a video signal (analog charge signal) outputted from a solid-state imaging device (image sensor) and the like to digital data corresponding to the analog charge signal and outputs the converted digital data.

The digital data outputted from the analog front-end device is subjected to various types of image processing including luminance signal processing, color separation and color matrix processing and the like performed by a signal processing circuit such as a digital signal processor (DSP). In this relation, since power consumption and noise must be reduced, it is necessary to reduce the number of signals transmitted between the front-end device and a signal processing circuit. To reduce the number of signals, disclosed is a device that has a plurality of n-bit A/D converters for converting the outputs of respective channels of an image sensor to digital signals and a plurality of PS conversion sections for converting the outputs of the n-bit A/D converters to serial data according to the output of a PLL circuit, to thereby reduce the number of signals transmitted to a signal processing circuit and the like (see Japanese Laid-Open Patent Publication No. 2005-244709, for example).

However, the analog front-end device described above has the following problem. The analog front-end device is also provided with CDS/AGC sections for extracting analog image signals of the number corresponding to the number of channels from the analog charge signal outputted from the image sensor, analog-digital (A/D) converters for converting the signals outputted from the CDS/AGC sections and other components, in addition to the PS conversion sections described above. The processing by the CDS/AGC sections and the A/D converters proceeds simultaneously with the data transmission to a signal processing circuit such as a DSP. Therefore, aliasing components of operation noise of an output buffer having large energy and radio-frequency noise of a clock for serial data output multiplied to a higher frequency than a pixel clock may adversely affect pulses for driving the image sensor used at the signal readout from the image sensor, output signals of the image sensor and other analog signals used inside the analog front-end device. This causes deterioration in signal S/N and discernment of aliasing noise and fixed pattern noise on the image.

### SUMMARY OF THE INVENTION

An object of the present invention is preventing deterioration of the S/N performance of signals handled by an image sensor, an analog-digital converter and the like even if operation noise occurs with data output.

The analog front-end device of the present invention is an analog front-end device for converting an analog charge signal to digital data and outputting the digital data, the analog charge signal being outputted from an image sensor for photoelectrically converting a light image of an object, the device including: an analog-digital converter for generating digital data corresponding to the analog charge signal; a memory for storing therein digital data generated by the analog-digital converter; a memory control section for reading digital data stored in the memory during the time period when the output of the image sensor is invalid; and a digital data output section for receiving digital data read from the memory and outputting the digital data externally.

### BRIEF DESCRIPTION OF THE DRAWINGS

FIG. 1 is a block diagram of an analog front-end device of an embodiment of the present invention.

FIG. 2 is a timing chart illustrating operation of the analog front-end device.

### DESCRIPTION OF THE PREFERRED EMBODIMENTS

Hereinafter, an embodiment of the present invention will be described with reference to the accompanying drawings.

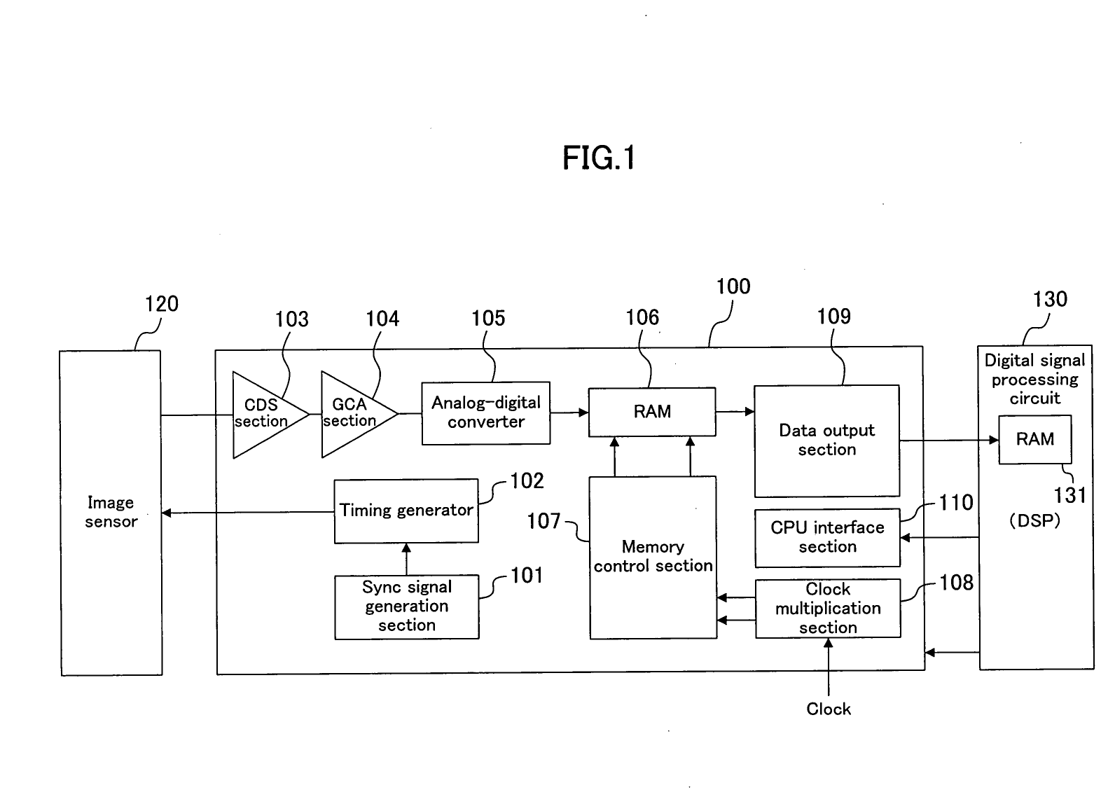

FIG. 1 is a block diagram of an analog front-end device of an embodiment of the present invention. As shown in FIG. 1, an analog front-end device 100 includes a sync signal generation section 101, a timing generator 102, a correlated double sampling (CDS) section 103, a gain control amplifier (GCA) section 104, an analog-digital (A/D) converter 105, a random access memory (RAM) 106, a memory control section 107, a clock multiplication section 108, a digital data output section 109 and a central processing unit (CPU) interface section 110. The analog front-end device 100 converts an image signal outputted from an image sensor 120 to image signal data as digital data and outputs the image signal data to a digital signal processing circuit 130. Note that the illustrated analog front-end device 100 shows the case that the number of output channels is 1 (1 ch).

The image sensor 120 linked to the analog front-end device 100 converts imaged light incident thereon via a lens (not shown) to an analog charge signal (image signal as an analog dot sequential signal) with photodiodes and the like.

The image sensor 120 outputs an image signal of one line periodically in synchronization with drive pulses (vertical drive pulses and horizontal drive pulses) supplied. More specifically, the image sensor 120 outputs a valid image signal of one line during the time period when a horizontal sync signal HBLK is low. The time period during which the image sensor 120 is outputting a valid image signal is called a valid data output period, and the time period during which the output of the image signal is invalid is called an invalid data period. In this embodiment, the time period during which the horizontal sync signal HBLK is low corresponds to the valid data output period, while the time period during which the horizontal sync signal HBLK is high corresponds to the invalid data period (which is also called the horizontal blanking period).

The digital signal processing circuit 130 is a digital signal processor (DSP) performing various types of image processing such as luminance signal processing, color separation and color matrix processing. The digital signal processing circuit 130 has a RAM 131 for temporarily storing therein data received from the analog front-end device 100, so that the operation of capturing data outputted from the analog front-end device 100 can be made asynchronously to the operation of image processing and the like.

(Configuration of Each Component of Analog Front-End Device 100)

The sync signal generation circuit 101 generates a periodic sync signal (horizontal sync signal HBLK described above).

The timing generator 102 generates pulses (vertical drive pulses and horizontal drive pulses) for driving the image sensor 120 according to the output of the sync signal generation circuit 101.

The CDS section 103 reduces noise included in the output of the image sensor 120 (analog image signal) based on correlated double sampling (CDS) and the like. More specifically, the CDS section 103, which has a sample/hold circuit, reduces 1/f noise with the sample/hold circuit and converts the resultant signal to a continuous signal.

The GCA section 104 performs gain control for the output of the CDS section 103 to give predetermined amplitude, and also performs feedback control for the DC component.

The A/D converter 105 converts the output of the GCA section 104 to image signal data (RGB data) as a digital signal.

The RAM 106 is a memory in which the output of the A/D converter 105 is temporarily stored.

The memory control section 107 controls data write and read into/from the RAM 106. More specifically, the memory control section 107 writes the output of the A/D converter 105 into the RAM 106 during the time period when valid data is being outputted from the image sensor 120. During the horizontal blanking period, valid data of one line stored in the RAM 106 is read from the RAM 106. This readout is performed in synchronization with a clock (multiplied clock) obtained by multiplying an input clock received outside the analog front-end device 100.

The clock multiplication section 108 multiplies the input clock received externally to output the multiplied clock.

The digital data output section 109 outputs data read from the RAM 106 to the digital signal processing circuit 130 during the horizontal blanking period in the form of parallel data or serial data. This output is made in synchronization with the multiplied clock.

The CPU interface section 110 accesses a register inside the analog front-end device 100 for initial setting, operation mode change and the like under instructions from an external CPU and DSP.

(Operation of Analog Front-End Device 100)

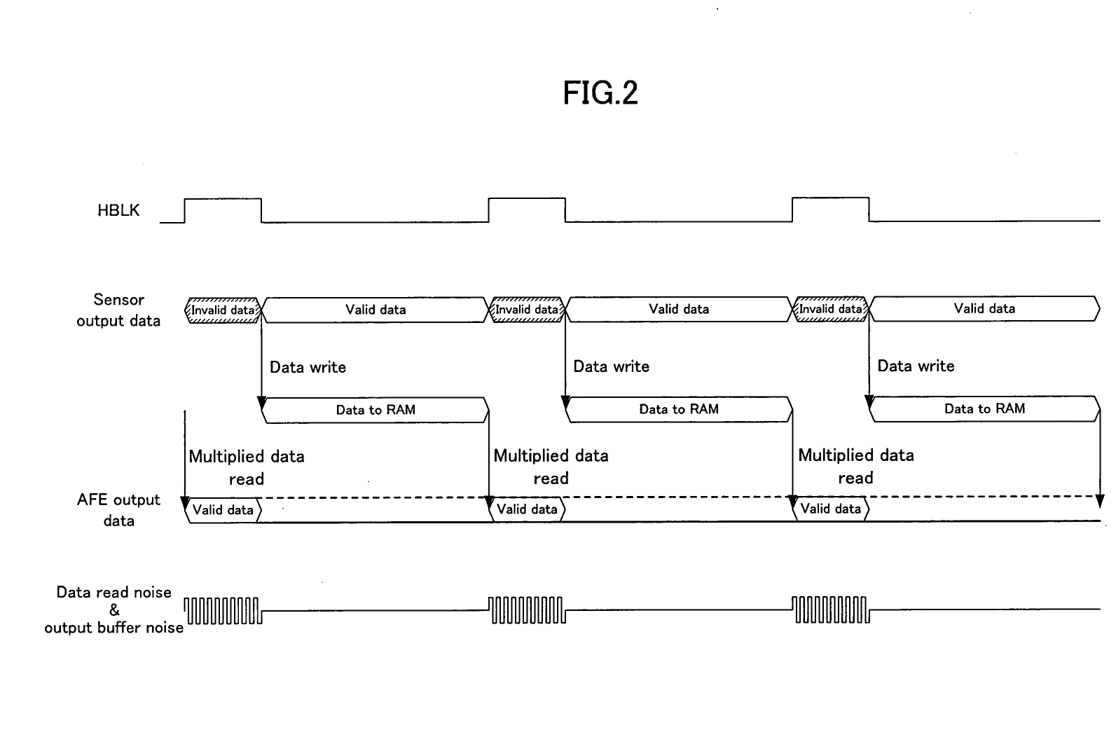

The operation of the analog front-end device 100 will be described with reference to the timing chart of FIG. 2.

In response to vertical drive pulses and horizontal drive pulses generated by the timing generator 102, the image sensor 120 outputs an image signal at a predetermined period. The image signal outputted from the image sensor 120 is supplied to the A/D converter 105 after being noise-reduced by the CDS section 103 and then gain-controlled to predetermined amplitude by the GCA section 104.

The A/D converter 105 AD converts the received image signal and outputs the resultant signal as valid data. The memory control section 107 stores the valid data outputted from the A/D converter 105 in the RAM 106. The memory control section 107 then reads valid data of one line stored in the RAM 106 during the next horizontal blanking period in synchronization with the multiplied clock outputted from the clock multiplication section 108. The digital data output section 109 outputs the valid data read by the memory control section 107 to the digital signal processing circuit 130 in synchronization with the multiplied clock. Operation noise due to data output therefore occurs during the horizontal blanking period.

The digital signal processing circuit 130 stores the valid data of one line received from the digital data output section 109 in a RAM 131 for subsequent predetermined image processing.

As described above, the analog front-end device 100 outputs data, not during the valid data output period, but during the horizontal blanking period. Thus, even though operation noise occurs due to data output, it is possible to prevent deterioration of the S/N performance of signals handled by the image sensor 120, the CDS section 103, the GCA section 104 and the A/D converter 105.

In the case that the analog front-end device 100 is configured to output data externally as parallel data, the electrical level of data output from the digital data output section 109 may be fixed during the valid data output period. This can reduce the power supply/GND noise components due to operation of an output buffer to zero, and thus reduce noise affecting pulses for driving the image sensor.

The digital data output section 109 may be configured to have a differential amplifier to allow data to be outputted externally as LVDS-based serial data. The LVDS, standing for low voltage differential signaling, is a known I/O standard method for converting a parallel signal to a low voltage differential serial signal for transmission. In the case of outputting data as LVDS-based serial data, the constant current source of the differential amplifier may be turned off and the output level may be set at fixed logic during the valid data output period. This can reduce the high-frequency power supply/GND noise components due to the LVDS operation to zero. Also, the power consumption of the digital data output section 109 can be greatly reduced.

The memory control section 107 may be configured to output the address for accessing the RAM 106 in the form of a gray code. This can reduce internal horizontal sync noise.

The memory control section 107 may also be configured to write the output of the A/D converter 105 into the RAM 106 before start of the valid data output period. With this configuration, in the case that write is started after a delay of a fixed time in response to valid data input, discontinuous internal noise may be made continuous, and thus internal horizontal sync vertical-stripe noise can be reduced.

The transfer rate of the digital data output section 109 may be set so that data output is completed within the horizontal blanking period. More specifically, in the case that the digital data output section 109 is configured to output data as parallel data, the transfer clock rate is set in the following manner. First, the ratio of the valid data output period to the horizontal blanking period is calculated, to obtain an integer value (multiplication factor) by rounding up the decimal fraction of the calculated ratio value. The pixel clock is then multiplied by the multiplication factor to thereby generate the transfer clock. In the case that the digital data output section 109 is configured to output serial data by LVDS, the transfer clock rate is set in the following manner. First, the ratio of the valid data output period to the horizontal blanking period is calculated, to obtain an integer value by rounding up the decimal fraction of the calculated ratio value. The obtained integer value is multiplied by the integer value of the data bus width after A/D conversion, and the resultant integer value is used as the multiplication factor. The pixel clock is then multiplied by the multiplication factor to thereby generate the transfer clock.

The memory control section 107 may be configured to read digital data from the RAM 106 in reverse order starting from the final address. This permits a video left-right reversing function.

The RAM 106 may be configured to allow write of data thereinto from outside the analog front-end device 100. With this configuration, in testing during fabrication, for example, by writing data for testing into the RAM 106, it becomes possible to perform system checks of the link state of the system with another LSI (large scale integrated circuit) and the like.

In the case that the analog front-end device 100 serves as a master and supplies the sync signal to a link target (the digital signal processing circuit 130 in illustrated example), data may be handled as packets, and sync header data may be prefixed to the data. This permits data exchange with the link target without the necessity of using an independent output pin exclusive to the sync signal. That is, the number of link signals for devices linked downstream can be reduced.

In output of data as packets, the digital data output section 109 may be provided with a wait function, to allow data to be outputted as discontinuous data in a handshake mode to suit the operation status of the link target. This makes it possible to wait for data transmission to the link target for a fixed time if the data capture sequence of the link target is busy.

By incorporating the analog front-end device 100 in an imaging apparatus (digital camera) together with a lens and a monitor, it is possible to provide an imaging apparatus that can output high-quality sensor data.

The number of output channels in the analog front-end device 100 is not limited to 1 ch as illustrated, but can be determined according to the image sensor.

As described above, in the analog front-end device of the present invention, in which digital data generated by the A/D converter is outputted during the time period when the output of the image sensor is invalid, the operation of outputting digital data does not coincide with operation of other circuits such as the A/D converter. Thus, operation noise that may occur due to data output will not cause deterioration of the S/N performance of signals handled by the image sensor, the A/D converter and the like. The present invention is therefore useful as an analog front-end device that converts a video signal (analog charge signal) outputted from an image sensor for a digital camera and the like to digital data corresponding to the analog charge signal and outputs the digital data, and an imaging apparatus using such an analog front-end device.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. An analog front-end device for converting an analog charge signal to digital data and outputting the digital data, the analog charge signal being outputted from an image sensor for photoelectrically converting a light image of an object, the device comprising:
an analog-digital converter for generating digital data corresponding to the analog charge signal;
a memory for storing therein digital data generated by the analog-digital converter;
a memory control section for reading digital data stored in the memory during the time period when the output of the image sensor is invalid; and
a digital data output section for receiving digital data read from the memory and outputting the digital data externally.

2. The device of claim 1, wherein the memory has a capacity of storing therein digital data of at least one line, and
the memory control section is configured to write digital data generated by the analog digital converter into the memory during the time period when the output of the image sensor is valid and read digital data from the memory during a horizontal blanking period.

3. The device of claim 1, wherein the digital data output section is configured to output digital data read from the memory externally as parallel data, and fixes the electrical level of data output during the time period when the output of the image sensor is valid.

4. The device of claim 1, wherein the digital data output section has a differential amplifier, is configured to convert digital data read from the memory to serial data by low voltage differential signaling (LVDS) and output the serial data, and turns off a constant current source of the differential amplifier and sets the output level at fixed logic during the time period when the output of the image sensor is valid.

5. The device of claim 1, wherein the memory control section is configured to output an address for assessing the memory in the form of a gray code.

6. The device of claim 1, wherein the memory control section is configured to write the output of the analog-digital converter into the memory before start of the time period when the output of the image sensor is valid.

7. The device of claim 1, wherein in the digital data output section, the transfer rate is set so as to complete output of data within a horizontal blanking period.

8. The device of claim 1, wherein the memory control section reads digital data from the memory in reverse order starting from the final address.

9. The device of claim 1, wherein the memory is configured to permit write of data from outside.

10. The device of claim 1, wherein the digital data output section outputs data as packets and prefixes sync header data to the output data.

11. The device of claim 1, wherein the digital data output section outputs data as packets and also as discontinuous data in a handshake mode.

12. An imaging apparatus comprising the analog front-end device of claim 1.
